(19) United States
(12) Patent Application Publication
(10) Pub. No.: US 2005/0038647 A1
(43) Pub. Date: Feb. 17, 2005

(54) Program product, method and system for detecting reduced speech

(75) Inventor: James K. Baker, Maitland, FL (US)

Correspondence Address: FOLEY AND LARDNER;SUITE 500, 3000 K STREET NW, WASHINGTON, DC, 20007, US

(73) Assignee: AURILAB, LLC

(21) Appl. No.: 10/637,667

(22) Filed: Aug. 11, 2003

(51) Int. Cl. G10L 15/00

(52) U.S. Cl. 704/231

(57) ABSTRACT

A program product, system and method for speech recognition, the program product comprising machine-readable program code for causing, when executed, a machine to perform the following method: detecting at least one speech element in an utterance of acoustic data which meets a criteria for potentially being reduced; presenting at least a portion of the utterance of acoustic data to a user with a prompt to determine if the speech element is reduced; and if the user verifies that a speech element in the utterance is reduced, training an acoustic model for a reduced form of the speech element using data related to the utterance.

### BACKGROUND OF THE INVENTION

In the art of speech recognition, there is a significant technical problem in detecting reduced speech, and providing a correct detection result therefor.

### SUMMARY OF THE INVENTION

In accordance with one embodiment of the present invention, a program product is provided for speech recognition, comprising machine-readable program code for causing, when executed, a machine to perform the following method: detecting at least one speech element in an utterance of acoustic data which meets a criteria for potentially being reduced; presenting at least a portion of the utterance of acoustic data to a user with a prompt to determine if the speech element is reduced; and if verification data is received from the user that the speech element in the utterance is reduced, training an acoustic model for a reduced form of the speech element using data related to the utterance.

In a further embodiment of the present invention, the criteria is that a portion of the acoustic data of the utterance matches data in a dictionary of reduced speech elements.

In a further embodiment of the present invention, the matched data in the dictionary comprises acoustic data for a reduced speech element.

In a further embodiment of the present invention, the matched data in the dictionary comprises word sequence context data.

In a further embodiment of the present invention, the dictionary is external to a speech recognition model in a base speech recognition process.

In a further embodiment of the present invention, the acoustic model for the reduced form is a discriminative model distinguishing said reduced form from the corresponding unreduced form.

In a further embodiment of the present invention, the criterion is that the speech element has a substantially lower amplitude than in an unreduced model for that speech element.

In a further embodiment of the present invention, the criterion is that the speech element has a substantially shorter duration than an average duration for the speech element.

In a further embodiment of the present invention, the criterion is that the speech element has acoustic characteristics that are less extreme than an unreduced model of the speech element.

In a further embodiment of the present invention, the criterion is that the speech element has acoustic characteristics that are more like an average speech sound than is an unreduced model for the speech element.

In a further embodiment of the present invention, the speech element is a vocalic and the criterion is that the speech element has acoustic characteristics more similar to a uniform acoustic tube than does an unreduced model for the speech element.

In a further embodiment of the present invention, the criterion is that the speech element has acoustic characteristics associated with an incomplete articulatory gesture.

In a further embodiment of the present invention, the unreduced speech element is formed by closure between the tongue and the roof of the mouth and the criterion is that the speech element has acoustic characteristics associated with only an incomplete or brief contact of the tongue with the roof of the mouth.

In a further embodiment of the present invention, a program product is provided for speech recognition, comprising machine-readable program code for causing, when executed, a machine to perform the following method: receiving a training utterance of acoustic data of a word sequence; detecting if the training utterance of acoustic data has at least one speech element which meets a criterion for potentially being reduced; presenting the utterance of acoustic data to a user with a prompt to determine if the speech element is reduced; and if verification data is received from the user that the speech element in the utterance is reduced, then associating a reduced designation with the speech element in the training utterance designated as reduced.

In a further embodiment of the present invention, a speech recognition process is provided, comprising: detecting at least one speech element in an utterance of acoustic data which meets a criteria for potentially being reduced; presenting at least a portion of the utterance of acoustic data to a user with a prompt to determine if the speech element is reduced; and if verification data is received from the user that the speech element in the utterance is reduced, training a discrimination model using data related to the utterance.

In a further embodiment of the present invention, a speech recognition method is provided, comprising: receiving a training utterance of acoustic data of a word sequence; detecting if the training utterance of acoustic data has at least one speech element which meets a criterion for potentially being reduced; presenting the utterance of acoustic data to a user with a prompt to determine if the speech element is reduced; and if verification data is received from the user that the speech element in the utterance is reduced, then associating a reduced designation with the speech element in the training utterance designated as reduced.

In a further embodiment of the present invention, a speech recognition system is provided, comprising: a detector for receiving at least one speech element in a utterance of acoustic data which meets a criteria for potentially being reduced; a presentation device for presenting at least a portion of the utterance of acoustic data to a user a with a prompt to determine if the speech element is reduced; and a computer training device that, if verification data is received from the user that the speech element in the utterance is reduced, trains an acoustic model for a reduced form of the speech element using data related to the utterance.

In a further embodiment of the present invention, a speech recognition system is provided, comprising: a receiver for receiving a training utterance of acoustic data of a word sequence; a detector for detecting if the training utterance of acoustic data has at least one speech element which meets a criterion for potentially being reduced; a presentation device for presenting the utterance of acoustic data to a user with a prompt to determine if the speech element is reduced; and logic for, if verification data is received from the user that the speech element in the utterance is reduced, then associating a reduced designation with the speech element in the training utterance designated as reduced.

### BRIEF DESCRIPTION OF THE DRAWINGS

FIG. 1 is a flowchart of an implementation of one embodiment of the present invention.

FIG. 2 is a schematic block diagram of an embodiment of the present invention.

FIG. 3 is a flowchart of an implementation of a further embodiment of the present invention.

### DETAILED DESCRIPTION OF EMBODIMENTS OF THE INVENTION

Definitions

The following terms may be used in the description of the invention and include new terms and terms that are given special meanings.

“Linguistic element” is a unit of written or spoken natural or artificial language. In some embodiments of some inventions, the “language” may be a purely artificial construction with allowed sequences of elements determined by a formal grammar. In other embodiments, the language will be either a natural language or at least a model of a natural language. In a speech recognition task, each linguistic element will generally be associated with an interval of speech and thus will also be a speech element. In a handwriting or optical character recognition task, each linguistic element will generally be associated with a sequence of pen strokes or with a portion of an image. In natural language processing tasks based on textual data, each linguistic element will be a unit of written language, such as a word.

“Speech element” is an interval of speech with an associated name or linguistic element. The name may be the word, syllable or phoneme being spoken during the interval of speech, or may be an abstract symbol such as an automatically generated phonetic symbol that represents the system's labeling of the sound that is heard during the speech interval. As an element within the surrounding sequence of speech elements, each speech element is also a linguistic element.

“Priority queue.” in a search system is a list (the queue) of hypotheses rank ordered by some criterion (the priority). In a speech recognition search, each hypothesis is a sequence of speech elements or a combination of such sequences for different portions of the total interval of speech being analyzed. The priority criterion may be a score which estimates how well the hypothesis matches a set of observations, or it may be an estimate of the time at which the sequence of speech elements begins or ends, or any other measurable property of each hypothesis that is useful in guiding the search through the space of possible hypotheses. A priority queue may be used by a stack decoder or by a branch-and-bound type search system. A search based on a priority queue typically will choose one or more hypotheses, from among those on the queue, to be extended. Typically each chosen hypothesis will be extended by one speech element. Depending on the priority criterion, a priority queue can implement either a best-first search or a breadth-first search or an intermediate search strategy.

“Best first search” is a search method in which at each step of the search process one or more of the hypotheses from among those with estimated evaluations at or near the best found so far are chosen for further analysis.

“Breadth-first search” is a search method in which at each step of the search process many hypotheses are extended for further evaluation. A strict breadth-first search would always extend all shorter hypotheses before extending any longer hypotheses. In speech recognition whether one hypothesis is “shorter” than another (for determining the order of evaluation in a breadth-first search) is often determined by the estimated ending time of each hypothesis in the acoustic observation sequence. The frame-synchronous beam search is a form of breadth-first search, as is the multi-stack decoder.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Frame synchronous beam search” is a search method which proceeds frame-by-frame. Each active hypothesis is evaluated for a particular frame before proceeding to the next frame. The frames may be processed either forwards in time or backwards. Periodically, usually once per frame, the evaluated hypotheses are compared with some acceptance criterion. Only those hypotheses with evaluations better than some threshold are kept active. The beam consists of the set of active hypotheses.

“Stack decoder” is a search system that uses a priority queue. A stack decoder may be used to implement a best first search. The term stack decoder also refers to a system implemented with multiple priority queues, such as a multi-stack decoder with a separate priority queue for each frame, based on the estimated ending frame of each hypothesis. Such a multi-stack decoder is equivalent to a stack decoder with a single priority queue in which the priority queue is sorted first by ending time of each hypothesis and then sorted by score only as a tie-breaker for hypotheses that end at the same time. Thus a stack decoder may implement either a best first search or a search that is more nearly breadth first and that is similar to the frame synchronous beam search.

“Branch and bound search” is a class of search algorithms based on the branch and bound algorithm. In the branch and bound algorithm the hypotheses are organized as a tree. For each branch at each branch point, a bound is computed for the best score on the subtree of paths that use that branch. That bound is compared with a best score that has already been found for some path not in the subtree from that branch. If the other path is already better than the bound for the subtree, then the subtree may be dropped from further consideration. A branch and bound algorithm may be used to do an admissible A* search. More generally, a branch and bound type algorithm might use an approximate bound rather than a guaranteed bound, in which case the branch and bound algorithm would not be admissible. In fact for practical reasons, it is usually necessary to use a non-admissible bound just as it is usually necessary to do beam pruning. One implementation of a branch and bound search of the tree of possible sentences uses a priority queue and thus is equivalent to a type of stack decoder, using the bounds as look-ahead scores.

“Admissible A* search.” The term A* search is used not just in speech recognition but also to searches in a broader range of tasks in artificial intelligence and computer science. The A* search algorithm is a form of best first search that generally includes a look-ahead term that is either an estimate or a bound on the score portion of the data that has not yet been scored. Thus the A* algorithm is a form of priority queue search. If the look-ahead term is a rigorous bound (making the procedure “admissible”), then once the A* algorithm has found a complete path, it is guaranteed to be the best path. Thus an admissible A* algorithm is an instance of the branch and bound algorithm.

“Score” is a numerical evaluation of how well a given hypothesis matches some set of observations. Depending on the conventions in a particular implementation, better matches might be represented by higher scores (such as with probabilities or logarithms of probabilities) or by lower scores (such as with negative log probabilities or spectral distances). Scores may be either positive or negative. The score may also include a measure of the relative likelihood of the sequence of linguistic elements associated with the given hypothesis, such as the a priori probability of the word sequence in a sentence.

“Dynamic programming match scoring” is a process of computing the degree of match between a network or a sequence of models and a sequence of acoustic observations by using dynamic programming. The dynamic programming match process may also be used to match or time-align two sequences of acoustic observations or to match two models or networks. The dynamic programming computation can be used for example to find the best scoring path through a network or to find the sum of the probabilities of all the paths through the network. The prior usage of the term “dynamic programming” varies. It is sometimes used specifically to mean a “best path match” but its usage for purposes of this patent covers the broader class of related computational methods, including “best path match,” “sum of paths” match and approximations thereto. A time alignment of the model to the sequence of acoustic observations is generally available as a side effect of the dynamic programming computation of the match score. Dynamic programming may also be used to compute the degree of match between two models or networks (rather than between a model and a sequence of observations). Given a distance measure that is not based on a set of models, such as spectral distance, dynamic programming may also be used to match and directly time-align two instances of speech elements.

“Best path match” is a process of computing the match between a network and a sequence of acoustic observations in which, at each node at each point in the acoustic sequence, the cumulative score for the node is based on choosing the best path for getting to that node at that point in the acoustic sequence. In some examples, the best path scores are computed by a version of dynamic programming sometimes called the Viterbi algorithm from its use in decoding convolutional codes. It may also be called the Dykstra algorithm or the Bellman algorithm from independent earlier work on the general best scoring path problem.

“Sum of paths match” is a process of computing a match between a network or a sequence of models and a sequence of acoustic observations in which, at each node at each point in the acoustic sequence, the cumulative score for the node is based on adding the probabilities of all the paths that lead to that node at that point in the acoustic sequence. The sum of paths scores in some examples may be computed by a dynamic programming computation that is sometimes called the forward-backward algorithm (actually, only the forward pass is needed for computing the match score) because it is used as the forward pass in training hidden Markov models with the Baum-Welch algorithm.

“Hypothesis” is a hypothetical proposition partially or completely specifying the values for some set of speech elements. Thus, a hypothesis is a grouping of speech elements, which may or may not be in sequence. However, in many speech recognition implementations, the hypothesis will be a sequence or a combination of sequences of speech elements. Corresponding to any hypothesis is a set of models, which may, as noted above in some embodiments, be a sequence of models that represent the speech elements. Thus, a match score for any hypothesis against a given set of acoustic observations, in some embodiments, is actually a match score for the concatenation of the set of models for the speech elements in the hypothesis.

“Set of hypotheses” is a collection of hypotheses that may have additional information or structural organization supplied by a recognition system. For example, a priority queue is a set of hypotheses that has been rank ordered by some priority criterion; an n-best list is a set of hypotheses that has been selected by a recognition system as the best matching hypotheses that the system was able to find in its search. A hypothesis lattice or speech element lattice is a compact network representation of a set of hypotheses comprising the best hypotheses found by the recognition process in which each path through the lattice represents a selected hypothesis.

“Selected set of hypotheses” is the set of hypotheses returned by a recognition system as the best matching hypotheses that have been found by the recognition search process. The selected set of hypotheses may be represented, for example, explicitly as an n-best list or implicitly as the set of paths through a lattice. In some cases a recognition system may select only a single hypothesis, in which case the selected set is a one element set. Generally, the hypotheses in the selected set of hypotheses will be complete sentence hypotheses; that is, the speech elements in each hypothesis will have been matched against the acoustic observations corresponding to the entire sentence. In some implementations, however, a recognition system may present a selected set of hypotheses to a user or to an application or analysis program before the recognition process is completed, in which case the selected set of hypotheses may also include partial sentence hypotheses. Such an implementation may be used, for example, when the system is getting feedback from the user or program to help complete the recognition process.

“Look-ahead” is the use of information from a new interval of speech that has not yet been explicitly included in the evaluation of a hypothesis. Such information is available during a search process if the search process is delayed relative to the speech signal or in later passes of multi-pass recognition. Look-ahead information can be used, for example, to better estimate how well the continuations of a particular hypothesis are expected to match against the observations in the new interval of speech. Look-ahead information may be used for at least two distinct purposes. One use of look-ahead information is for making a better comparison between hypotheses in deciding whether to prune the poorer scoring hypothesis. For this purpose, the hypotheses being compared might be of the same length and this form of look-ahead information could even be used in a frame-synchronous beam search. A different use of look-ahead information is for making a better comparison between hypotheses in sorting a priority queue. When the two hypotheses are of different length (that is, they have been matched against a different number of acoustic observations), the look-ahead information is also referred to as missing piece evaluation since it estimates the score for the interval of acoustic observations that have not been matched for the shorter hypothesis.

“Missing piece evaluation” is an estimate of the match score that the best continuation of a particular hypothesis is expected to achieve on an interval of acoustic observations that was yet not matched in the interval of acoustic observations that have been matched against the hypothesis itself. For admissible A* algorithms or branch and bound algorithms, a bound on the best possible score on the unmatched interval may be used rather than an estimate of the expected score.

“Sentence” is an interval of speech or a sequence of speech elements that is treated as a complete unit for search or hypothesis evaluation. Generally, the speech will be broken into sentence length units using an acoustic criterion such as an interval of silence. However, a sentence may contain internal intervals of silence and, on the other hand, the speech may be broken into sentence units due to grammatical criteria even when there is no interval of silence. The term sentence is also used to refer to the complete unit for search or hypothesis evaluation in situations in which the speech may not have the grammatical form of a sentence, such as a database entry, or in which a system is analyzing as a complete unit an element, such as a phrase, that is shorter than a conventional sentence.

“Spotting” is the process of detecting an instance of a speech element or sequence of speech elements by directly detecting an instance of a good match between the model(s) for the speech element(s) and the acoustic observations in an interval of speech without necessarily first recognizing one or more of the adjacent speech elements.

“Pruning” is the act of making one or more active hypotheses inactive based on the evaluation of the hypotheses. Pruning may be based on either the absolute evaluation of a hypothesis or on the relative evaluation of the hypothesis compared to the evaluation of some other hypothesis.

“Pruning threshold” is a numerical criterion for making decisions of which hypotheses to prune among a specific set of hypotheses.

“Pruning margin” is a numerical difference that may be used to set a pruning threshold. For example, the pruning threshold may be set to prune all hypotheses in a specified set that are evaluated as worse than a particular hypothesis by more than the pruning margin. The best hypothesis in the specified set that has been found so far at a particular stage of the analysis or search may be used as the particular hypothesis on which to base the pruning margin.

“Beam width” is the pruning margin in a beam search system. In a beam search, the beam width or pruning margin often sets the pruning threshold relative to the best scoring active hypothesis as evaluated in the previous frame.

“Best found so far” Pruning and search decisions may be based on the best hypothesis found so far. This phrase refers to the hypothesis that has the best evaluation that has been found so far at a particular point in the recognition process. In a priority queue search, for example, decisions may be made relative to the best hypothesis that has been found so far even though it is possible that a better hypothesis will be found later in the recognition process. For pruning purposes, hypotheses are usually compared with other hypotheses that have been evaluated on the same number of frames or, perhaps, to the previous or following frame. In sorting a priority queue, however, it is often necessary to compare hypotheses that have been evaluated on different numbers of frames. In this case, in deciding which of two hypotheses is better, it is necessary to take account of the difference in frames that have been evaluated, for example by estimating the match evaluation that is expected on the portion that is different or possibly by normalizing for the number of frames that have been evaluated. Thus, in some systems, the interpretation of best found so far may be based on a score that includes a look-ahead score or a missing piece evaluation.

“Modeling” is the process of evaluating how well a given sequence of speech elements match a given set of observations typically by computing how a set of models for the given speech elements might have generated the given observations. In probability modeling, the evaluation of a hypothesis might be computed by estimating the probability of the given sequence of elements generating the given set of observations in a random process specified by the probability values in the models. Other forms of models, such as neural networks may directly compute match scores without explicitly associating the model with a probability interpretation, or they may empirically estimate an a posteriori probability distribution without representing the associated generative stochastic process.

“Training” is the process of estimating the parameters or sufficient statistics of a model from a set of samples in which the identities of the elements are known or are assumed to be known. In supervised training of acoustic models, a transcript of the sequence of speech elements is known, or the speaker has read from a known script. In unsupervised training, there is no known script or transcript other than that available from unverified recognition. In one form of semi-supervised training, a user may not have explicitly verified a transcript but may have done so implicitly by not making any error corrections when an opportunity to do so was provided.

“Acoustic model” is a model for generating a sequence of acoustic observations, given a sequence of speech elements. The acoustic model, for example, may be a model of a hidden stochastic process. The hidden stochastic process would generate a sequence of speech elements and for each speech element would generate a sequence of zero or more acoustic observations. The acoustic observations may be either (continuous) physical measurements derived from the acoustic waveform, such as amplitude as a function of frequency and time, or may be observations of a discrete finite set of labels, such as produced by a vector quantizer as used in speech compression or produced as the output of a phonetic recognizer. The continuous physical measurements would generally be modeled by some form of parametric probability distribution such as a Gaussian distribution or a mixture of Gaussian distributions. Each Gaussian distribution would be characterized by the mean of each observation measurement and the covariance matrix. If the covariance matrix is assumed to be diagonal, then the multi-variant Gaussian distribution would be characterized by the mean and the variance of each of the observation measurements. The observations from a finite set of labels would generally be modeled as a non-parametric discrete probability distribution. However, other forms of acoustic models could be used. For example, match scores could be computed using neural networks, which might or might not be trained to approximate a posteriori probability estimates. Alternately, spectral distance measurements could be used without an underlying probability model, or fuzzy logic could be used rather than probability estimates.

“Language model” is a model for generating a sequence of linguistic elements subject to a grammar or to a statistical model for the probability of a particular linguistic element given the values of zero or more of the linguistic elements of context for the particular speech element.

“General Language Model” may be either a pure statistical language model, that is, a language model that includes no explicit grammar, or a grammar-based language model that includes an explicit grammar and may also have a statistical component.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words or linguistic elements are allowed to be the next linguistic element in the sequence. For each such word or linguistic element, there is a specification (say by a labeled arc in the network) as to what the state of the system will be at the end of that next word (say by following the arc to the node at the end of the arc). A third form of grammar representation is as a database of all legal sentences.

“Grammar state” is a representation of the fact that, for purposes of determining which sequences of linguistic elements form a grammatical sentence, certain sets of sentence-initial sequences may all be considered equivalent. In a finite-state grammar, each grammar state represents a set of sentence-initial sequences of linguistic elements. The set of sequences of linguistic elements associated with a given state is the set of sequences that, starting from the beginning of the sentence, lead to the given state. The states in a finite-state grammar may also be represented as the nodes in a directed graph or network, with a linguistic element as the label on each arc of the graph. The set of sequences of linguistic elements of a given state correspond to the sequences of linguistic element labels on the arcs in the set of paths that lead to the node that corresponds to the given state. For purposes of determining what continuation sequences are grammatical under the given grammar, all sequences that lead to the same state are treated as equivalent. All that matters about a sentence-initial sequence of linguistic elements (or a path in the directed graph) is what state (or node) it leads to. Generally, speech recognition systems use a finite state grammar, or a finite (though possibly very large) statistical language model. However, some embodiments may use a more complex grammar such as a context-free grammar, which would correspond to a denumerable, but infinite number of states. In some embodiments for context-free grammars, non-terminal symbols play a role similar to states in a finite-state grammar, but the associated sequence of linguistic elements for a non-terminal symbol will be for some span of linguistic elements that may be in the middle of the sentence rather than necessarily starting at the beginning of the sentence. Any finite-state grammar may alternately be represented as a context-free grammar.

“Stochastic grammar” is a grammar that also includes a model of the probability of each legal sequence of linguistic elements.

“Pure statistical language model” is a statistical language model that has no grammatical component. In a pure statistical language model, generally every possible sequence of linguistic elements will have a non-zero probability.

“Entropy” is an information theoretic measure of the amount of information in a probability distribution or the associated random variables. It is generally given by the formula
E=Σᵢpᵢ log(pᵢ), where the logarithm is taken base 2 and the entropy is measured in bits.

“Perplexity” is a measure of the degree of branchiness of a grammar or language model, including the effect of non-uniform probability distributions. In some embodiments it is 2 raised to the power of the entropy. It is measured in units of active vocabulary size and in a simple grammar in which every word is legal in all contexts and the words are equally likely, the perplexity will equal the vocabulary size. When the size of the active vocabulary varies, the perplexity is like a geometric mean rather than an arithmetic mean.

“Decision Tree Question” in a decision tree, is a partition of the set of possible input data to be classified. A binary question partitions the input data into a set and its complement. In a binary decision tree, each node is associated with a binary question.

“Classification Task” in a classification system is a partition of a set of target classes.

“Hash function” is a function that maps a set of objects into the range of integers {0, 1, . . . , N−1}. A hash function in some embodiments is designed to distribute the objects uniformly and apparently randomly across the designated range of integers. The set of objects is often the set of strings or sequences in a given alphabet.

“Lexical retrieval and prefiltering.” Lexical retrieval is a process of computing an estimate of which words, or other speech elements, in a vocabulary or list of such elements are likely to match the observations in a speech interval starting at a particular time. Lexical prefiltering comprises using the estimates from lexical retrieval to select a relatively small subset of the vocabulary as candidates for further analysis. Retrieval and prefiltering may also be applied to a set of sequences of speech elements, such as a set of phrases. Because it may be used as a fast means to evaluate and eliminate most of a large list of words, lexical retrieval and prefiltering is sometimes called “fast match” or “rapid match”.

“Pass.” A simple speech recognition system performs the search and evaluation process in one pass, usually proceeding generally from left to right, that is, from the beginning of the sentence to the end. A multi-pass recognition system performs multiple passes in which each pass includes a search and evaluation process similar to the complete recognition process of a one-pass recognition system. In a multi-pass recognition system, the second pass may, but is not required to be, performed backwards in time. In a multi-pass system, the results of earlier recognition passes may be used to supply look-ahead information for later passes.

“Phoneme” is a single unit of sound in spoken language, roughly corresponding to a letter in written language. For example, the word “speech” consists of the sequence of phonemes /s/ /p/ /i/ /ch/. In formal linguistic usage, a phoneme corresponds not to a single sound, but to a group of related elementary sounds. Which elementary sounds are grouped together and considered as an instance of a single phoneme depends on the language being discussed. For example, the /p/ in “speech” is different than the /p/ in “peach” (the /p/ in “peach” is aspirated, that is there is a puff of air produced after the /p/ is released). However, the difference between these two sounds is never used in English to distinguish between two words and they are grouped together as instances of the same phoneme in English, although they are considered as distinct phonemes in some other languages.

“Phonetic label” is the label generated by a speech recognition system indicating the recognition system's choice as to the sound occurring during a particular speech interval. Often the alphabet of potential phonetic labels is chosen to be the same as the alphabet of phonemes, but there is no requirement that they be the same. Some systems may distinguish between phonemes or phonemic labels on the one hand and phones or phonetic labels on the other hand. Strictly speaking, a phoneme is a linguistic abstraction. The sound labels that represent how a word is supposed to be pronounced, such as those taken from a dictionary, are phonemic labels. The sound labels that represent how a particular instance of a word is spoken by a particular speaker are phonetic labels. The two concepts, however, are intermixed and some systems make no distinction between them.

A “broad phonetic label” is a phonetic label from a set of labels (or “alphabet”) that roughly corresponds to the set of phonemes. Some systems make no distinction between phonemes and broad phonetic labels.

A “narrow phonetic label” is a phonetic label from a set of labels (or “alphabet”) that distinguishes some similar sounds that are instances of a single phoneme. For example, a set of narrow phonetic labels might distinguish an aspirated /p/ from an unaspirated /p/.

A “phonetic feature” is qualitative property of one aspect of a speech sound. Frequently the property of a phonetic feature of a particular sound relates to the manner that the particular sound is articulated or to the place in the vocal tract that is most characteristic of the particular sound (usually the place of greatest constriction). For example, one feature of vowels is “height”, with values such as “high”, “mid”, and “low”. A feature for stops would be place, with values such as “labial”, “alveolar”, and “velar”. Other features for stops include voicing and aspiration.

A “binary phonetic feature” is a phonetic feature that only has two possible values. Examples of binary features include “voiced/unvoiced”, “aspirated/unaspirated”, “vocalic/non-vocalic”, and “nasalized/un-nasalized”.

A “phonetic class label” is a label for a group of related phonetic labels. For example, all the stops consonant might be grouped together to form a class “stop”. Or all the consonants formed at the lips might be grouped together to form a class “labial”. In general, two phonetic classes may overlap and one phonetic class may be a subset of a larger phonetic class.

A “stream” of labels (phonetic labels, phonetic class labels or phoneme labels) is a time-ordered set of labels such that each label is associated with a particular point in time or with a particular time interval. Typically each label is associated with a time interval that adjoins but does not overlap the next time interval, so that the set of labels also form a sequence. In some embodiments, the time intervals may overlap and the set of labels may be represented as a lattice rather than as a sequence. A sequence of labels may also be treated as a stream even if there are no associated time points, by using the sequence index itself as a time unit. Thus any sequence of labels is also a stream.

A “vocabulary” is a set of linguistic elements. Typically the word “vocabulary” refers to a set of higher level linguistic elements such as words rather than lower level elements such as phonemes or letters.

An “alphabet” is a set of linguistic elements. Typically the word “alphabet” refers to a set of lower level linguistic elements such as phonemes or letters rather than higher level elements such as words. For example, the written symbols for the set of phonemes in a particular language is a phonemic alphabet. The written symbols for a set of phonetic labels is a phonetic alphabet. Sometimes the same alphabet is used for a set of broad phonetic labels as for the set of phonemes.

A “dictionary” is a vocabulary of linguistic elements with associated information. For example, a phonemic dictionary consists of a vocabulary of words with the associated pronunciations for each word. A spelling dictionary consists of a vocabulary of words with the associated orthographic spelling of each word in letters. In speech recognition, especially language modeling, often a word is identified by its spelling. Thus a typical phonemic dictionary in speech recognition associates each word spelling with one or more pronunciations. A dictionary may also have associated syntactic and semantic information.

The invention is described below with reference to drawings. These drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention will be described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

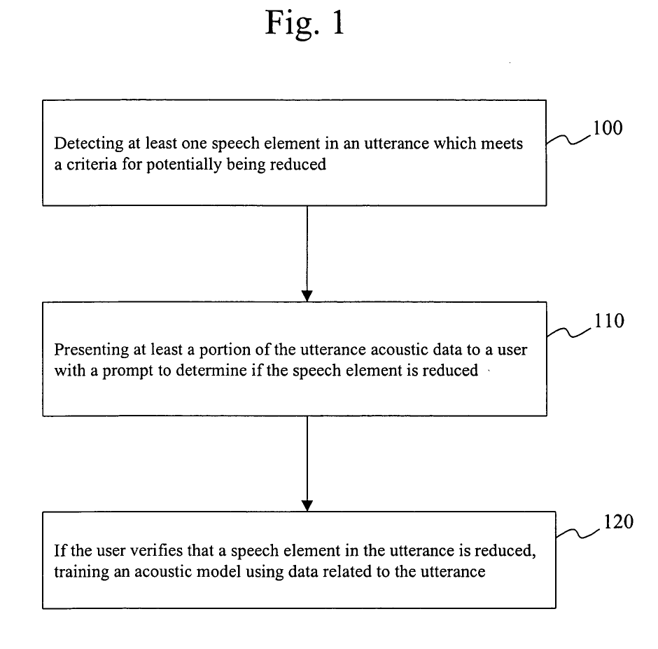

Referring now to FIG. 1, there is shown a flowchart for implementing one embodiment of the present invention. Referring to block 100, the operation is provided of detecting at least one speech element in an utterance of acoustic data which meets a criteria for potentially being reduced. There are a wide variety of criteria that may be used to obtain an indication that a detected speech element in an utterance is reduced. By way of example, in one embodiment of the invention the criteria may be that a portion of the acoustic data of the utterance matches data in a dictionary of reduced speech elements. For example, the matched data in the dictionary may comprise acoustic data for a reduced speech element. Alternatively, the matched data in the dictionary may comprise word sequence context data. Note that the dictionary may be external to a speech recognition model in a base speech recognition process or may be internal to the speech recognition process.

In a further embodiment of the invention, the criterion is that the acoustic data for the detected speech element has a substantially lower amplitude than in an unreduced model for that speech element. In a yet further embodiment of the invention, the criterion is that the acoustic data for the detected speech element has a substantially shorter duration as compared to an average duration for the speech element in the unreduced model therefor. In a yet further embodiment of the invention, the criterion is that the detected speech element has acoustic characteristics that are that are less extreme as compared to an unreduced model of the speech element, that is the criterion is that the detected speech element is more similar acoustically to a neutral speech element model than is the unreduced model for the speech element. The neutral model in this embodiment may be an average model for several speech elements including the particular speech element of which reduced instances are being detected. In a yet further embodiment of the invention, the criterion is that the speech element has acoustic characteristics that are more like an average speech sound than is an unreduced model for the speech element. In a yet further embodiment of the invention, the speech element is a vocalic and the criterion is that the speech element has acoustic characteristics more similar to a uniform acoustic tube than does an unreduced model for the speech element. In a yet further embodiment, the criterion is that the speech element has acoustic characteristics associated with an incomplete articulatory gesture, which characteristics are held in storage. In yet a further embodiment, the unreduced speech element is formed by closure between the tongue and the roof of the mouth and the criterion is that the acoustic data for the speech element has acoustic characteristics associated with only an incomplete or brief contact of the tongue with the roof of the mouth, which characteristics are held in storage.

Referring to block 110, the operation is provided of presenting at least a portion of the utterance of acoustic data to a user with a prompt to determine if the speech element is reduced. This presentation of a portion of the utterance may be accomplished in one embodiment by replaying the recorded audio data for the utterance back to the user via a speaker.

Referring to block 120, the operation is provided of, if verification data is received from the user that the speech element in the utterance is reduced, training an acoustic model using data related to the utterance. Such training may be accomplished using a variety of techniques. For example, the Baum-Welch algorithm (see Jelinek pp 147-163 or Huang pp 389-398 or the pseudo-code below) may be used. In a further embodiment, block 30 may train a discriminative model, that is, a model that is optimized to discriminate between reduced and unreduced speech elements. The discriminative model may be trained by a variety of techniques. For example, the discriminative model may use a neural network trained using the back-propagation algorithm (see Huang pp 159-163 or the pseudo-code below).

An embodiment of pseudo-code for Baum-Welch training is provided below as an example.

For all frames f of all instances of model {
Initialize alpha at beginning of each instance;
For all states s of model {

alpha[f,s] = alpha[s−1,f−1] * TransProb[s−1] + alpha[s,f−1] *

StayProb[s];

alpha[f,s] = alpha[f,s] * ObsProb(Data[f],s)

}

}
Backwards for all frames f of all instances of model {

Initialize beta at frame after end frame for each instance;
For all states s of model {

temp_beta[f+1,s] = beta[f+1,s] * ObsProb(Data[f+1],s);
beta[f,s] = TransProb[s] * temp_beta[f+1,s1] +
StayProb[s] *

temp_beta[f+1,s]

}

}
Clear counts;
For all frames of all instances of model {

For all states s of model {

Count[s] = Count[s] + alpha[f,s] * beta[f,s];
TransCount[s] = TransCount[s] + alpha[f,s] * TransProb[s] *

ObsProb(Data[f+1],s+1) * beta[f+1,s+1];

StayCount[s] = StayCount[s] + alpha[f,s] * StayProb[s] *

ObsProb(Data[f+1],s) * beta[f+1,s];

For all dimensions k of data vector {

DataCount[s,k] = DataCount[s,k] + Data[f,k] * alpha[f,s] *

beta[f,s];

DataSqrCount[s,k] = DataSqrCount[s,k] + Data[f,k] *
Data[f,k]

* alpha[f,s] * beta[f,s];
}

}

}
For all states s of model {

TransProb[s] = TransCount[s] / Count[s];
StayProb[s] = StayCount[s] / Count[s];
For all dimensions k of data vector {

Mean[s,k] = DataCount[s,k] / Count[s];
SumSqr = DataSqrCount[s,k] / Count[s];
Var[s,k] = SumSqr − Mean[s,k] * Mean[s,k];
Std[s,k] = Sqrt(Var[s,k]);

}

}
Pseudo-code for back-propagation training
Iterate until convergence criterion is met {

Clear all delta[i,j];
For all frames f of all instances of model and all unreduced instances

of phoneme{

For all input nodes k {a[k] = Data[f,k];}
For all nodes j {

sum = 0;
For all nodes i, i < j {

sum = sum + a[i] * w[i,j];

}
a[j] = 1 / (1 + exp(−sum);

}
For output node J {

if instance is reduced d[J] = −(1 −a[J]);
if instance is unreduced d[J] = a[j];

}
For all nodes i {

sum = 0;
For all nodes j, j > i {

sum = sum + (1 − a[j])*a[j]*d[j]*w[i,j];
delta[i.j] = delta[i,j] + (1−a[j])*a[j]*a[i];

}
d[i] = sum;

}

}
For all nodes j {

For all nodes i, i<j {

w[i,j] = w[i,j] + scale * delta[i,j];
// scale is an empirically adjusted convergence rate fraction

F / (number of frames);

}

}

}

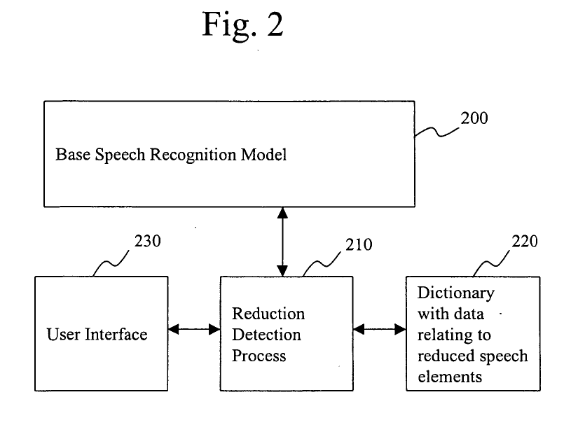

Referring to FIG. 2, an embodiment of the present invention is provided for implementing the present invention. Referring to block 200, a base speech recognition model in a speech recognition processor is shown. Any convenient speech recognition model may be used, including a frame-synchronous beam search (see Huang pp 622-626) or a multi-stack decoder (see Jelinek pp 99-103 or Huang pp 639-640). The particular speech recognition model is not limiting on the invention, and any current or future speech recognition model may be used.

Referring to block 210, a processor is provided for detecting at least one speech element in an utterance of acoustic data which meets a criteria for potentially being reduced. Example criteria for implementing this element are the same as were described for block 100 in FIG. 1. Referring to block 220, a dictionary with data relating to reduced speech elements is provided. The reduction detection process of block 210 compares one or more portions of the utterance to acoustic data representing reduced speech elements in the dictionary 220, looking for a match.

A user interface 230 is provided for receiving user input confirming whether or not the speech element is, in fact, reduced speech. The user interface 230 may comprise, for example, an acoustic device such as a speaker, microphone and/or a screen device for presenting a portion of the utterance of acoustic data to the user with a prompt to determine if the speech is reduced. Accordingly, in one embodiment, this operation can be accomplished by replaying the audio data for the recorded utterance back to the user via the speaker. Alternatively, the results of the speech recognition can be presented to the user either on a monitor or via a synthesization of the results, with a prompt to determine whether any of the speech elements are reduced speech.

If verification data is received from the user that the speech element in the utterance is reduced, then the base speech recognition processor 200 trains a discrimination model therein using data related to the utterance.

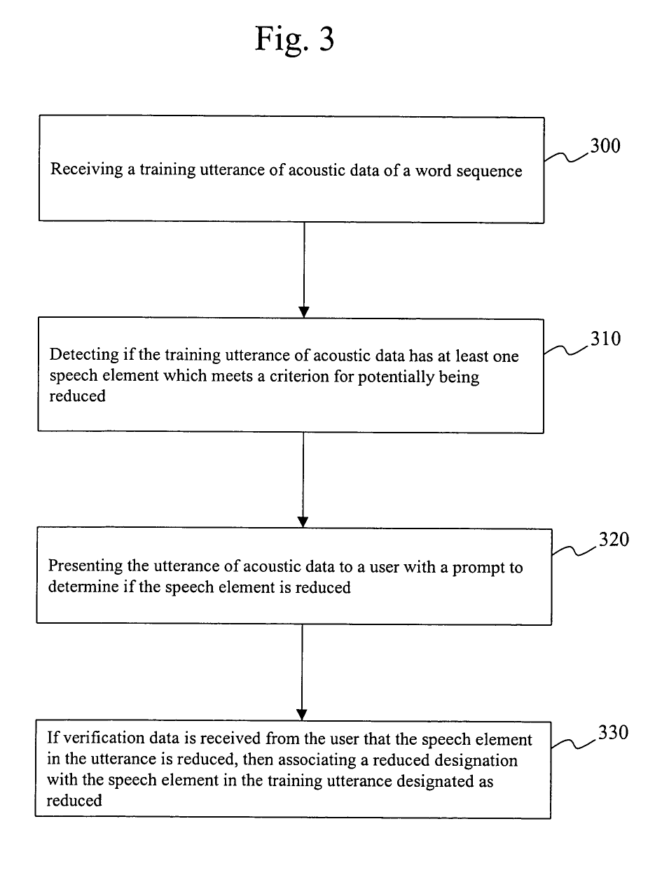

Referring to FIG. 3, an embodiment of the present invention is provided for creating a dictionary of reduced speech elements. In block 300 the operation is provided of receiving a training utterance of acoustic data of a word sequence via any convenient acoustic receiving device. By way of example, this operation could be implemented in one embodiment by receiving acoustic data via a microphone from a user making a set of utterances based on a script.

Referring to block 310, the operation is provided of detecting if the training utterance of acoustic data has at least one speech element which meets a criterion for potentially being reduced. Example criteria for implementing this element are the same as were described for block 100 in FIG. 1.

Referring to block 320, the operation is provided of presenting the utterance of acoustic data to a user with a prompt to determine if the speech element is reduced. The oral or visual means for making such a presentation to the user have been discussed above.

Referring to block 330, if verification data is received by any convenient oral or screen or other means from the user that the speech element in the utterance is reduced, then associating a reduced designation with the speech element in the training utterance designated as reduced. By way of example, the designation may comprise adding an indication in a data file associated with that portion of the utterance indicating that the portion comprises reduced speech. Note that the means for receiving the verification is not limiting on the invention, and the particular means of associating the reduced designation with the speech element is not limiting as well.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

1. A program product for speech recognition, comprising machine-readable program code for causing, when executed, a machine to perform the following method:
detecting at least one speech element in an utterance of acoustic data which meets a criteria for potentially being reduced;
presenting at least a portion of the utterance of acoustic data to a user with a prompt to determine if the speech element is reduced; and
if verification data is received from the user that the speech element in the utterance is reduced, training an acoustic model for a reduced form of the speech element using data related to the utterance.

2. The program product as defined in claim 1, wherein the criteria is that a portion of the acoustic data of the utterance matches data in a dictionary of reduced speech elements.

3. The program product as defined in claim 2, wherein the matched data in the dictionary comprises acoustic data for a reduced speech element.

4. The program product as defined in claim 2, wherein the matched data in the dictionary comprises word sequence context data.

5. The program product as defined in claim 2, wherein the dictionary is external to a speech recognition model in a base speech recognition process.

6. The program product as defined in claim 1, wherein said acoustic model for said reduced form is a discriminative model distinguishing said reduced form from the corresponding unreduced form.

7. The program product as defined in claim 1, wherein the criterion is that the speech element has a substantially lower amplitude than in an unreduced model for that speech element.

8. The program product as defined in claim 1, wherein the criterion is that the speech element has a substantially shorter duration than an average duration for the speech element.

9. The program product as defined in claim 1, wherein the criterion is that the speech element has acoustic characteristics that are less extreme than an unreduced model of the speech element.

10. The program product as defined in claim 1, wherein the criterion is that the speech element has acoustic characteristics that are more like an average speech sound than is an unreduced model for the speech element.

11. The program product as defined in claim 1, wherein the speech element is a vocalic and the criterion is that the speech element has acoustic characteristics more similar to a uniform acoustic tube than does an unreduced model for the speech element.

12. The program product as defined in claim 1, wherein the criterion is that the speech element has acoustic characteristics associated with an incomplete articulatory gesture.

13. The program product as defined in claim 1, wherein the unreduced speech element is formed by closure between the tongue and the roof of the mouth and the criterion is that the speech element has acoustic characteristics associated with only an incomplete or brief contact of the tongue with the roof of the mouth.

14. A program product for speech recognition, comprising machine-readable program code for causing, when executed, a machine to perform the following method:
receiving a training utterance of acoustic data of a word sequence;
detecting if the training utterance of acoustic data has at least one speech element which meets a criterion for potentially being reduced;
presenting the utterance of acoustic data to a user with a prompt to determine if the speech element is reduced; and
if verification data is received from the user that the speech element in the utterance is reduced, then associating a reduced designation with the speech element in the training utterance designated as reduced.

15. The program product as defined in claim 14, wherein the criterion is that the speech element has a substantially lower amplitude than in an unreduced model for that speech element.

16. The program product as defined in claim 14, wherein the criterion is that the speech element has a substantially shorter duration than an average duration for speech element.

17. The program product as defined in claim 14, wherein the criterion is that the speech element has acoustic characteristics that are less extreme than an unreduced model for the speech element.

18. The program product as defined in claim 14, wherein the criterion is that the speech element has acoustic characteristics that are more like an average speech sound than is an unreduced model for the speech element.

19. The program product as defined in claim 14, wherein the speech element is a vocalic and the criterion is that the speech element has acoustic characteristics more similar to a uniform acoustic tube than does an unreduced model for the speech element.

20. The program product as defined in claim 14, wherein the criterion is that the speech element has acoustic characteristics associated with an incomplete articulatory gesture.

21. The program product as defined in claim 14, wherein the unreduced speech element is formed by closure between the tongue and the roof of the mouth and the criterion is that the speech element has acoustic characteristics associated with only an incomplete or brief contact of the tongue with the roof of the mouth.

22 A speech recognition process, comprising:
detecting at least one speech element in an utterance of acoustic data which meets a criteria for potentially being reduced;
presenting at least a portion of the utterance of acoustic data to a user with a prompt to determine if the speech element is reduced; and
if verification data is received from the user that the speech element in the utterance is reduced, training a discrimination model using data related to the utterance.

23. The method as defined in claim 22, wherein the criteria is that a portion of the acoustic data of the utterance matches data in a dictionary of reduced speech elements.

24. The method as defined in claim 23, wherein the matched data in the dictionary comprises acoustic data for a reduced speech element.

25. The method as defined in claim 23, wherein the matched data in the dictionary comprises word sequence context data.

26. The method as defined in claim 22, wherein the dictionary is external to a speech recognition model in a base speech recognition process.

27. The method as defined in claim 22, wherein said acoustic model for said reduced form is a discriminative model distinguishing said reduced form from the corresponding unreduced form.

28. The method as defined in claim 22, wherein the criterion is that the speech element has a substantially lower amplitude than in an unreduced model for that speech element.

29. The method as defined in claim 22, wherein the criterion is that the speech element has a substantially shorter duration than an average duration for the speech element.

30. The method as defined in claim 22, wherein the criterion is that the speech element has acoustic characteristics that are less extreme than an unreduced model of the speech element.

31. The method as defined in claim 22, wherein the criterion is that the speech element has acoustic characteristics that are more like an average speech sound than is an unreduced model for the speech element.

32. The method as defined in claim 22, wherein the speech element is a vocalic and the criterion is that the speech element has acoustic characteristics more similar to a uniform acoustic tube than does an unreduced model for the speech element.

33. The method as defined in claim 22, wherein the criterion is that the speech element has acoustic characteristics associated with an incomplete articulatory gesture.

34. The method as defined in claim 22, wherein the unreduced speech element is formed by closure between the tongue and the roof of the mouth and the criterion is that the speech element has acoustic characteristics associated with only an incomplete or brief contact of the tongue with the roof of the mouth.

35. A speech recognition method, comprising:
receiving a training utterance of acoustic data of a word sequence;
detecting if the training utterance of acoustic data has at least one speech element which meets a criterion for potentially being reduced;
presenting the utterance of acoustic data to a user with a prompt to determine if the speech element is reduced; and
if verification data is received from the user that the speech element in the utterance is reduced, then associating a reduced designation with the speech element in the training utterance designated as reduced.

36. The method as defined in claim 35, wherein the criterion is that the speech element has a substantially lower amplitude than in an unreduced model for that speech element.

37. The method as defined in claim 35, wherein the criterion is that the speech element has a substantially shorter duration than an average duration for speech element.

38. The method as defined in claim 35, wherein the criterion is that the speech element has acoustic characteristics that are less extreme than an unreduced model for the speech element.

39. The method as defined in claim 35, wherein the criterion is that the speech element has acoustic characteristics that are more like an average speech sound than is an unreduced model for the speech element.

40. The method as defined in claim 35, wherein the speech element is a vocalic and the criterion is that the speech element has acoustic characteristics more similar to a uniform acoustic tube than does an unreduced model for the speech element.

41. The method as defined in claim 35, wherein the criterion is that the speech element has acoustic characteristics associated with an incomplete articulatory gesture.

42. The method as defined in claim 35, wherein the unreduced speech element is formed by closure between the tongue and the roof of the mouth and the criterion is that the speech element has acoustic characteristics associated with only an incomplete or brief contact of the tongue with the roof of the mouth.

43. A speech recognition system, comprising:
a detector for receiving at least one speech element in an utterance of acoustic data which meets a criteria for potentially being reduced;
a presentation device for presenting at least a portion of the utterance of acoustic data to a user with a prompt to determine if the speech element is reduced; and
a computer training device that, if verification data is received from the user that the speech element in the utterance is reduced, trains an acoustic model for a reduced form of the speech element using data related to the utterance.

44. The system as defined in claim 43, wherein the criteria is that a portion of the acoustic data of the utterance matches data in a dictionary of reduced speech elements.

45. The system as defined in claim 44, wherein the matched data in the dictionary comprises acoustic data for a reduced speech element.

46. The system as defined in claim 44, wherein the matched data in the dictionary comprises word sequence context data.

47. The system as defined in claim 44, wherein the dictionary is external to a speech recognition model in a base speech recognition process.

48. The system as defined in claim 43, wherein said acoustic model for said reduced form is a discriminative model distinguishing said reduced form from the corresponding unreduced form.

49. The system as defined in claim 43, wherein the criterion is that the speech element has a substantially lower amplitude than in an unreduced model for that speech element.

50. The system as defined in claim 43, wherein the criterion is that the speech element has a substantially shorter duration than an average duration for the speech element.

51. The system as defined in claim 43, wherein the criterion is that the speech element has acoustic characteristics that are less extreme than an unreduced model of the speech element.

52. The system as defined in claim 43, wherein the criterion is that the speech element has acoustic characteristics that are more like an average speech sound than is an unreduced model for the speech element.

53. The system as defined in claim 43, wherein the speech element is a vocalic and the criterion is that the speech element has acoustic characteristics more similar to a uniform acoustic tube than does an unreduced model for the speech element.

54. The system as defined in claim 43, wherein the criterion is that the speech element has acoustic characteristics associated with an incomplete articulatory gesture.

55. The system as defined in claim 43, wherein the unreduced speech element is formed by closure between the tongue and the roof of the mouth and the criterion is that the speech element has acoustic characteristics associated with only an incomplete or brief contact of the tongue with the roof of the mouth.

56. A speech recognition system, comprising:
a receiver for receiving a training utterance of acoustic data of a word sequence;
a detector for detecting if the training utterance of acoustic data has at least one speech element which meets a criterion for potentially being reduced;
a presentation device for presenting the utterance of acoustic data to a user with a prompt to determine if the speech element is reduced; and
logic for, if verification data is received from the user that the speech element in the utterance is reduced, then associating a reduced designation with the speech element in the training utterance designated as reduced.

57. The system as defined in claim 56, wherein the criterion is that the speech element has a substantially lower amplitude than in an unreduced model for that speech element.

58. The system as defined in claim 56, wherein the criterion is that the speech element has a substantially shorter duration than an average duration for speech element.

59. The system as defined in claim 56, wherein the criterion is that the speech element has acoustic characteristics that are less extreme than an unreduced model for the speech element.

60. The system as defined in claim 56, wherein the criterion is that the speech element has acoustic characteristics that are more like an average speech sound than is an unreduced model for the speech element.

61. The system as defined in claim 56, wherein the speech element is a vocalic and the criterion is that the speech element has acoustic characteristics more similar to a uniform acoustic tube than does an unreduced model for the speech element.

62. The system as defined in claim 56, wherein the criterion is that the speech element has acoustic characteristics associated with an incomplete articulatory gesture.

63. The system as defined in claim 56, wherein the unreduced speech element is formed by closure between the tongue and the roof of the mouth and the criterion is that the speech element has acoustic characteristics associated with only an incomplete or brief contact of the tongue with the roof of the mouth.
